(19) United States
(12) Patent Application Publication
(10) Pub. No.: US 2011/0037339 A1
(43) Pub. Date: Feb. 17, 2011

(54) CONCENTRATED WINDING MACHINES WITH REDUCED TORQUE RIPPLE AND METHODS FOR DESIGNING THE SAME

(75) Inventors: KHWAJA M. RAHMAN, TROY, MI (US); MATTHEW D. LABA, OAKLAND, MI (US); EDWARD L. KAISER, ORION, MI (US); PETER J. SAVAGIAN, BLOOMFIELD HILLS, MI (US)

Correspondence Address: INGRASSIA FISHER & LORENZ, P.C. (GM), 7010 E. COCHISE ROAD, SCOTTSDALE, AZ, 85253, US

(73) Assignee: GM GLOBAL TECHNOLOGY OPERATIONS, INC., DETROIT, MI (US)

(21) Appl. No.: 12/540,164

(22) Filed: Aug. 12, 2009

(51) Int. Cl. H02K 1/16; G06F 17/50; G06G 7/63; H02K 15/02

(52) U.S. Cl. 310/216.072; 700/103; 29/596; 703/7

(57) ABSTRACT

Systems and methods are provided for a motor having a concentrated winding construction with reduced torque ripple. A motor comprises a stator including a plurality of tooth segments disposed circumferentially to establish a hollow core and a rotor rotatably disposed inside the hollow core. The plurality of tooth segments define a plurality of slot openings associated with a plurality of slots. Each slot of the plurality of slots has a slot opening and at least one slot opening of the plurality of slot openings is asymmetric with respect to the plurality of slot openings.

### TECHNICAL FIELD

Embodiments of the subject matter described herein relate generally to electric motors, and more particularly relate to concentrated winding machines with reduced torque ripple.

### BACKGROUND

Permanent magnet motors may produce undesirable torque ripple that may result in unwanted vibration and noise. Conventional permanent magnet motors skew either the rotor or the stator in an attempt to reduce the torque ripple. However, skewing may introduce manufacturing complexity and increase cost. Skewing may also lower machine torque, and thus, lower machine performance.

### BRIEF SUMMARY

In accordance with one embodiment, an apparatus is provided for a motor. The motor comprises a stator including a plurality of tooth segments disposed circumferentially to establish a hollow core and a rotor rotatably disposed inside the hollow core. The plurality of tooth segments define a plurality of slot openings associated with a plurality of slots. Each slot of the plurality of slots has a slot opening and at least one slot opening of the plurality of slot openings is asymmetric with respect to the plurality of slot openings.

In accordance with another embodiment, an apparatus is provided for a motor for use in a vehicle. The motor comprises a plurality of tooth segments disposed circumferentially to provide a hollow core, a rotor rotatably disposed inside the hollow core, and a plurality of permanent magnets embedded in the rotor. Each tooth segment includes a respective tooth having a set of stator windings disposed about its sidewalls. The plurality of tooth segments define a plurality of slot openings, wherein each slot opening corresponds to a winding slot configured to house a segment of the set of stator windings of adjacent teeth. A first slot opening of the plurality of slot openings is asymmetric with respect to a second slot opening of the plurality of slot openings.

In another embodiment, a method is provided for constructing a motor having a concentrated winding construction. The method comprises determining simulated torque ripple for a plurality of proposed motors with various stator slot opening configurations and identifying an optimized motor from the plurality of proposed motors based on the simulated torque ripple. The method further comprises constructing a plurality of tooth segments configured to define a plurality of slot openings corresponding to the optimized motor when the plurality of tooth segments are arranged circumferentially and circumferentially disposing the plurality of teeth to form a stator. At least one slot opening of the plurality of slot openings is asymmetric with respect to the plurality of slot openings.

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

### BRIEF DESCRIPTION OF THE DRAWINGS

A more complete understanding of the subject matter may be derived by referring to the detailed description and claims when considered in conjunction with the following figures, wherein like reference numbers refer to similar elements throughout the figures.

FIG. 1 is a partial cross-sectional view of a permanent magnet motor in accordance with one embodiment;

FIG. 2 is a cross-sectional view of a stator having a segmented tooth winding construction suitable for use as the stator in the permanent magnet motor of FIG. 1 in accordance with one embodiment;

FIG. 3 is a cross-sectional view of a stator having an inserted tooth winding construction suitable for use as the stator in the permanent magnet motor of FIG. 1; and

FIG. 4 is a flow diagram of a motor design process in accordance with one embodiment.

### DETAILED DESCRIPTION

The following detailed description is merely illustrative in nature and is not intended to limit the embodiments of the subject matter or the application and uses of such embodiments. As used herein, the word “exemplary” means “serving as an example, instance, or illustration.” Any implementation described herein as exemplary is not necessarily to be construed as preferred or advantageous over other implementations. Furthermore, there is no intention to be bound by any expressed or implied theory presented in the preceding technical field, background, brief summary or the following detailed description.

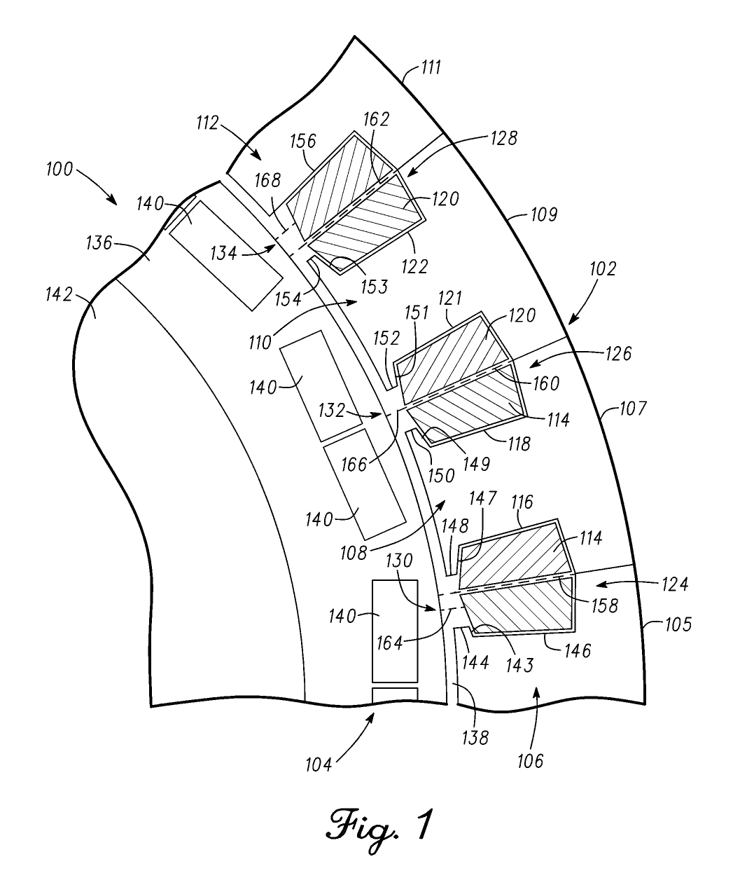

FIG. 1 depicts a partial cross-sectional view of a permanent magnet motor 100 in accordance with an exemplary embodiment. The view of FIG. 1 represents ⅛th of a complete cross-sectional view of the motor 100. In an exemplary embodiment, the motor 100 includes a stator 102 and a rotor 104 rotatably disposed within the stator 102. The motor 100 may form parts of various automobile components such as, for example, a traction machine for a fuel cell or electric vehicle or a motor/generator for a hybrid vehicle. The motor 100 may also be used in applications unrelated to motor vehicles, such as consumer appliances, medical instruments, tools, etc.

In an exemplary embodiment, the motor 100 is realized as a concentrated winding machine, such that the stator 102 comprises a plurality of separate tooth segments 105, 107, 109, 111 that are disposed or otherwise arranged circumferentially, with each individual tooth segment having a respective tooth 106, 108, 110, 112 having one or more phases of windings disposed about (e.g., wound or slid about) the tooth 106, 108, 110, 112. For example, a first tooth 108 has a first set of windings 114 disposed about its sidewalls 116, 118, a second tooth 110 has a second set of windings 120 disposed about its sidewalls 121, 122, and so on.

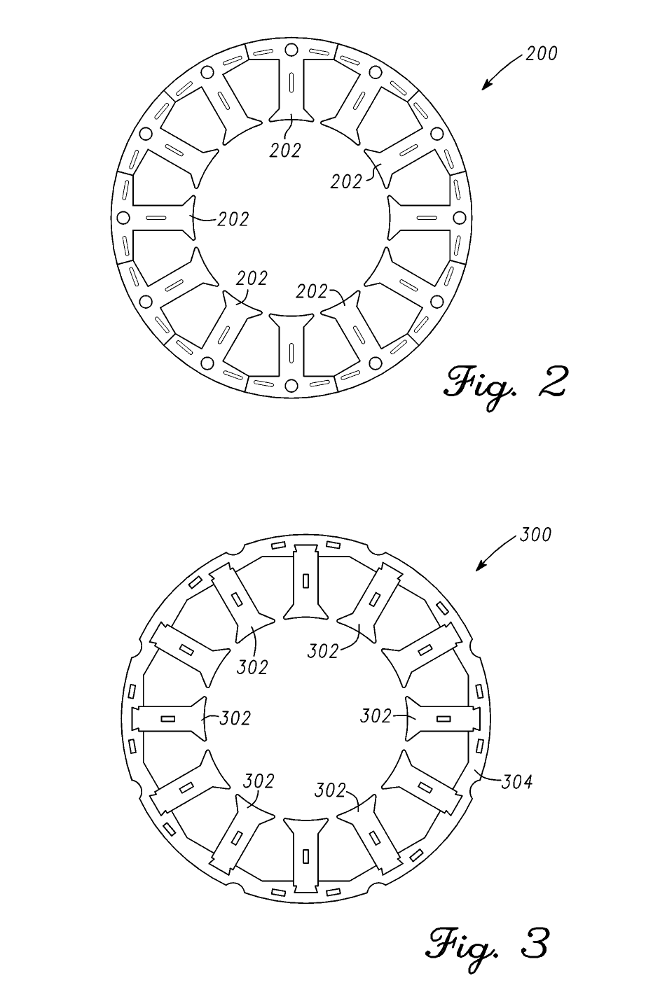

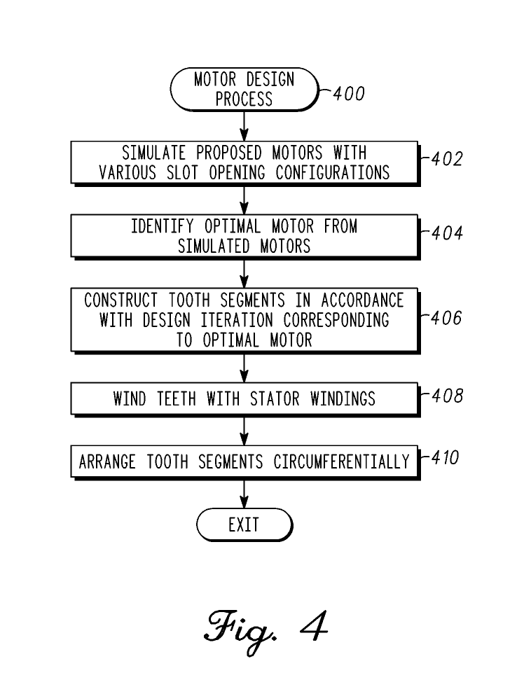

FIG. 2 depicts a segmented tooth concentrated winding construction of a stator 200 comprising a plurality of tooth segments 202 arranged circumferentially to form the stator 200 and FIG. 3 depicts an inserted tooth winding construction of a stator 300 comprising a plurality of teeth 302 inserted into slots in a stator core 304 such that the teeth are arranged circumferentially to form the stator 300. It should be noted that FIG. 1 depicts a segmented tooth winding construction of the stator 102 where the teeth 106, 108, 110, 112 together form a generally cylindrical shape having a hollow core when arranged circumferentially to form the stator 102 that does not have a separate stator core. However, it should be appreciated that the subject matter described herein may also be implemented for a concentrated winding machine with inserted tooth concentration, where the individual teeth are inserted into a stator core, as will be appreciated in the art.

As shown in FIG. 1, the sidewalls of adjacent teeth 106, 108, 110, 112 form a plurality of winding slots 124, 126, 128 when the teeth 106, 108, 110, 112 are arranged circumferentially. Each of the winding slots 124, 126, 128 has a respective slot opening 130, 132, 134. As discussed in further detail below, the locations and/or the widths of the slot openings 130, 132, 134 with respect to the slots 124, 126, 128 are adjusted in a manner that reduces torque ripple of the motor 100. It should be noted that by virtue of the concentrated winding construction (e.g., segmented tooth construction or inserted tooth construction), the stator windings are predisposed within the winding slots 124, 126, 128, that is, the one or more phases (or sets) of stator windings disposed about each tooth 106, 108, 110, 112 are disposed about (e.g., wound or slid about) the tooth 106, 108, 110, 112 prior to circumferentially arranging the tooth segments 105, 107, 109, 111 to form the stator 102. Thus, the winding slots 124, 126, 128 house or otherwise correspond to segments of the stator windings of the teeth adjacent to the respective winding slot but the winding slots and/or slot openings are not used for inserting the stator windings into the stator 102 or otherwise wind the stator windings about the stator 102 (e.g., about teeth 106, 108, 110, 112). For example, as shown in FIG. 1, slot 126 houses or otherwise corresponds to a segment of the stator windings 114 about tooth 108 and a segment of the stator windings 120 about tooth 110, but the slot opening 132 is not used for winding and/or inserting the stator windings 114, 120 into the slot 126.

In an exemplary embodiment, each slot opening 130, 132, 134 is defined by tips 143, 147, 149, 151, 153 of the adjacent pair of teeth that form the respective slot 124, 126, 128. In this regard, each tooth 106, 108, 110, 112 may include one or more tips (a tooth tip) that define a sidewall 144, 148, 150, 152, 154, 156 of a respective slot opening 130, 132, 134 adjacent to the respective tooth 106, 108, 110, 112. As used herein, a tooth tip should be understood as referring to a portion of a tooth that is proximate the rotor 104 and extends substantially perpendicular to a central axis of a respective slot to define a sidewall of the respective slot opening, or in other words, a portion of the tooth proximate the rotor 104 that extends circumferentially from to a respective sidewall of the tooth.

For example, as shown in FIG. 1, a first slot opening 130 is defined by a first tooth tip sidewall 144 and a second tooth tip sidewall 148, and the first slot 124 is defined by a first body sidewall 146 and a second body sidewall 116. In this regard, the first tooth tip 143 extends circumferentially from the body sidewall 146 of tooth 106 toward the first slot 124, that is, in a direction substantially perpendicular to the central axis 158 of the slot 124, with the first tooth tip sidewall 144 being aligned substantially parallel to the central axis 158 of the slot 124. In a similar manner, the second tooth tip 147 extends circumferentially from the body sidewall 116 of tooth 108 toward the first slot 124, that is, in a direction substantially perpendicular to the central axis 158 of the slot 124, with the second tooth tip sidewall 148 being aligned substantially parallel to the central axis 158 of the slot 124. A second slot opening 132 of the second slot 126 is defined by a third tooth tip sidewall 150 and a fourth tooth tip sidewall 152, and the second slot 126 is defined by a third body sidewall 118 and a fourth body sidewall 121. In this regard, the third tooth tip 149 extends circumferentially from the sidewall 118 of tooth 108 and the fourth tooth tip 151 extends circumferentially from the body sidewall 121 of tooth 110, in a similar manner as described above in regards to the first slot opening 130. The third slot opening 134 is similarly defined, however, as shown, the third slot opening 134 of the third slot 128 is defined by a fifth tooth tip sidewall 154 and a body sidewall 156 of the tooth 112, that is, the tooth 112 does not include a tooth tip for establishing a sidewall 156 of the third slot opening 134. It should be noted that in alternative embodiments, the tooth 112 may include a tooth tip to define the sidewall 156 of the third slot opening 134, in a similar manner as set forth above. As described in greater detail below, the teeth 106, 108, 110, 112 are configured such that the sidewalls 144, 148, 150, 152, 154, 156 define slot openings 130, 132, 134 with respect to the slots 124, 126, 128 in a manner that reduces the torque ripple of the motor 100.

The rotor 104 includes a rotor core 136 that is formed by stacking a plurality of magnetic steel lamination sheets that, when stacked, together form the shape of a cylinder. The rotor core 136 is disposed in the hollow core of the stator 102, while being spaced at a predetermined distance from the stator core 102 such that a gap 138 is formed between the stator 102 and the rotor core 136. The rotor core 136 supports a plurality of permanent magnets 140 that are embedded into the rotor core 136. It should be noted that in practice, the arrangement and/or alignment of the permanent magnets 140 will vary depending on the needs of a particular application. In an exemplary embodiment, the permanent magnets 140 are realized as rare earth magnets such as neodymium iron boron or samarium cobalt magnets, although ceramic and alnico magnets may be used for other embodiments according to design requirements. In an exemplary embodiment, a rotary shaft 142 is inserted in a hollow region formed at the center of the rotor 104, and rotates together with the rotor 104. In accordance with one embodiment, the rotary shaft 142 comprises the automotive drive shaft for a vehicle.

During operation, when the rotor 104 moves via the rotary shaft 142 with respect to the stator 102, the permanent magnets 140 are moved past the windings 114, 120 and voltage is thus induced in the windings 114, 120 through electromagnetic induction, as will be appreciated in the art. Conversely, if current is supplied to the windings 114, 120 by, for example, by a battery (not shown), a magnetic field is consequently generated by the stator windings (e.g., windings 114, 120), which interacts with the permanent magnets 140 in the rotor 104 such that the rotor 104 and the attached rotary shaft 142 rotate to generate a rotary driving force.

Turning again to the slot openings 130, 132, 134 for each of the slots 124, 126, 128, torque ripple and cogging in the motor 100 is caused predominantly by the slotting effects between the rotor 104 (e.g., the slots or spaces between the permanent magnets 140) and the stator slots 124, 126, 128 and slot openings 130, 132, 134, as will be appreciated in the art. The torque ripple due to the interaction between rotor magnets 140 and a particular stator slot 124, 126, 128 and slot openings 130. 132. 134 can have either positive or negative values. In this regard, as described in greater detail below, in an exemplary embodiment, the locations of the slot openings 130, 132, 134 relative to the slots 124, 126, 128 are adjusted in a manner that tends to average the positive and negative torque ripple values and thereby reduces torque ripple. Thus, in accordance with one or more embodiments, the motor 100 has at least one slot opening 130, 132, 134 that is off-center with its respective slot 124, 126, 128, or in other words, the central axis of the slot opening is offset from or otherwise not aligned with the central axis of its respective slot.

For example, as shown in FIG. 1, the first slot opening 130 of the first slot 124 has a central axis 164 that is offset from (or not aligned with) the central axis 158 of the first slot 124, the second slot opening 132 of the second slot 126 has a central axis 166 that is aligned with the central axis 160 of the second slot 126, and the third slot opening 134 has a central axis 168 that is offset from the central axis 162 of the third slot 128, although at a different relative position as compared to the first slot opening 130. In this regard, in the illustrated embodiment, the slots 124, 126, 128 are arranged symmetrically with the slot openings 130, 132, 134 being arranged asymmetrically, that is the circumferential distance between the central axis 158 of the first slot 124 and the central axis 160 of the second slot 126 is equal to the circumferential distance between the central axis 160 of the second slot 126 and the central axis 162 of the third slot 128 while the circumferential distance between the central axis 164 of the first slot opening 130 and the central axis 166 of the second slot opening 132 is different than the circumferential distance between the central axis 166 of the second slot opening 132 and the central axis 168 of the third slot opening 134.

In addition, the width or size of the slot openings 130, 132, 134, that is, the width of the gap or space between opposing sidewalls, may be different for each respective slot 124, 126, 128. For example, the first slot opening 130 may have a width equal to the distance between sidewalls 144, 148 which is different from the width of the second slot opening 132 (i.e., the distance between sidewalls 150, 152) and/or the width of the third slot opening 134 (i.e., the distance between sidewalls 154, 156). Thus, each slot of the stator 102 may have a respective slot opening with a width or size unique from the other slots in addition to having a slot opening that is offset from the central axis of its respective slot. In other words, at least one slot opening 130, 132, 134 stator 102 is asymmetric with respect to the remaining slot openings 130, 132, 134 either in terms of its placement with respect to its respective slot 124, 126, 128 and/or in terms of the width or size of the slot opening 130, 132, 134 compared to the other slot openings 130, 132, 134.

It should be understood that FIG. 1 is a simplified representation of the motor 100 for purposes of explanation and is not intended to limit the scope or applicability of the subject matter described herein in any way. Thus, although FIG. 1 depicts an exemplary arrangement of slot openings 130, 132, 134, practical embodiments may employ numerous possible arrangements of slot openings without departing from the scope of the subject matter described herein.

Referring now to FIG. 4, in an exemplary embodiment, a motor design process 400 is performed to obtain a motor having an optimized positioning of slot openings. In an exemplary embodiment, the motor design process 400 begins by determining simulated torque ripple and average torque output for a plurality of proposed motors, with each proposed motor having a slot opening configuration unique from the remaining proposed motors (task 402). In this regard, each proposed motor includes a different arrangement or combination of slot opening positions with respect to their associated slots and/or a different combination of widths of the slot openings. In an exemplary embodiment, the simulated torque ripple and simulated torque output are obtained by varying stator slot and/or slot opening positions as well as the widths of the slot openings using finite element analysis (FEA) simulation tools for a number of design iterations of the stator slots and/or stator slot openings. In an exemplary embodiment, the motor design process 400 continues by identifying an optimized motor from the plurality of proposed motors, that is, the proposed motor with optimized slot opening positions and/or widths, based on the torque ripple and the average torque output (task 404). In this regard, it is desirable to decrease the torque ripple without substantially decreasing the average torque output of the motor. Accordingly, an “optimized” permanent magnet motor is one in which the torque ripple is decreased to the greatest extent without unacceptably lowering the average torque. For example, in one embodiment, the average torque output should not decrease by more than 4% with respect to the original motor (e.g., a non-optimized motor having uniform and/or symmetrical slot openings centered with the respective winding slots). In this regard, depending on the particular application, it may be possible to utilize FEA to identify a design iteration that reduces the average torque ripple while maintaining an average torque output which is approximately equal to the original torque output for the non-optimized motor. As a result, by virtue of varying the widths and/or positioning of the slot openings 130, 132, 134 with respect to the slots 124, 126, 128, the torque ripple of the motor 100 is reduced without compromising the output torque of the motor 100.

In an exemplary embodiment, the motor design process 400 continues by constructing a plurality of tooth segments for the stator of the optimized motor based on the identified design iteration (task 406). In this regard, at least one tooth segment is constructed with a tooth having one or more tooth tips, such that the plurality of tooth segments define the plurality of slot openings corresponding to the identified design iteration for the optimized motor when the tooth segments are arranged circumferentially. In an exemplary embodiment, the motor design process 400 continues by winding the teeth of the plurality of tooth segments with the one or more sets of stator windings that correspond to the respective tooth and/or winding slot for the particular design iteration (task 408). After winding each tooth, the motor design process 400 continues by circumferentially arranging the tooth segments, resulting in the stator of the optimized motor having a hollow core (task 410). In this regard, the tooth segments may be circumferentially arranged and then bound about the circumference of the tooth segments (e.g., for segmented tooth winding construction of FIG. 2) or inserted into slots of a stator core (e.g., for inserted tooth winding construction of FIG. 3). The rotor and/or rotor shaft may be subsequently disposed in the hollow core defined by the plurality of teeth and voltage and/or current applied to the set of stator windings disposed about the plurality of teeth to create a magnetic field causing rotation of the rotor and/or rotor shaft, as will be appreciated in the art. In this regard, the rotor and/or rotor shaft generate torque with reduced ripple in response to the voltage and/or current applied to the stator windings.

While at least one exemplary embodiment has been presented in the foregoing detailed description, it should be appreciated that a vast number of variations exist. It should also be appreciated that the exemplary embodiment or embodiments described herein are not intended to limit the scope, applicability, or configuration of the claimed subject matter in any way. Rather, the foregoing detailed description will provide those skilled in the art with a convenient road map for implementing the described embodiment or embodiments. It should be understood that various changes can be made in the function and arrangement of elements without departing from the scope defined by the claims, which includes known equivalents and foreseeable equivalents at the time of filing this patent application.

What is claimed is:

1. A motor comprising:
a stator including a plurality of tooth segments disposed circumferentially to establish a hollow core, wherein:
the plurality of tooth segments define a plurality of slot openings associated with a plurality of slots, each slot of the plurality of slots having a slot opening and at least one slot opening of the plurality of slot openings being asymmetric with respect to the plurality of slot openings; and
a rotor rotatably disposed inside the hollow core.

2. The motor of claim 1, wherein a first slot opening of the plurality of slot openings has a first width and a second slot opening of the plurality of slot openings has a second width, the first width being different from the second width.

3. The motor of claim 1, a first slot of the plurality of slots having a first slot opening, wherein a central axis of the first slot opening is not aligned with a central axis of the first slot.

4. The motor of claim 1, the stator having a concentrated winding construction, wherein each tooth segment of the plurality of tooth segments includes a tooth having a set of stator windings disposed about the tooth prior to disposing the plurality of tooth segments circumferentially.

5. The motor of claim 4, wherein the stator has a segmented tooth winding construction.

6. The motor of claim 4, the stator having an inserted winding construction, wherein each tooth segment of the plurality of tooth segments is inserted into a stator core to form the stator.

7. The motor of claim 1, the plurality of slots including a first slot having a first slot opening, a second slot having a second slot opening, and a third slot having a third slot opening, the second slot being adjacent to the first slot and the third slot being adjacent to the second slot, wherein:
the first slot opening is spaced apart from the second slot opening by a first distance;
the second slot opening is spaced apart from the third slot opening by a second distance; and
the first distance is different than the second distance.

8. The motor of claim 7, wherein the first slot is spaced apart from the second slot by a third distance, and the second slot is spaced apart from the third slot by a fourth distance, wherein the third distance is equal to the fourth distance.

9. The motor of claim 1, wherein the rotor is adapted to be coupled to a shaft of a vehicle.

10. A motor for use in a vehicle, the motor comprising:
a plurality of tooth segments disposed circumferentially to provide a hollow core, each tooth segment including a respective tooth having a set of stator windings disposed about its sidewalls, wherein:
the plurality of tooth segments define a plurality of slot openings, each slot opening corresponding to a winding slot configured to house a segment of the set of stator windings of adjacent teeth; and
a first slot opening of the plurality of slot openings is asymmetric with respect to a second slot opening of the plurality of slot openings;
a rotor rotatably disposed inside the hollow core; and
a plurality of permanent magnets embedded in the rotor.

11. The motor of claim 10, the first slot opening corresponding to a first winding slot, wherein a central axis of the first slot opening is offset from a central axis of the first winding slot by a first distance.

12. The motor of claim 11, the second slot opening corresponding to a second winding slot, wherein a central axis of the second slot opening is offset from a central axis of the second winding slot by a second distance, and the second distance is not equal to the first distance.

13. The motor of claim 10, wherein a width of the first slot opening is not equal to a width of the second slot opening.

14. The motor of claim 10, the first slot opening corresponding to a first winding slot and the second slot opening corresponding to a second winding slot, and a third slot opening of the plurality of slot openings corresponding to a third winding slot wherein:
the first slot opening is spaced apart from the second slot opening by a first distance;
the second slot opening is spaced apart from the third slot opening by a second distance; and
the first distance is different than the second distance.

15. The motor of claim 14, wherein:
the first winding slot is spaced apart from the second winding slot by a third distance;
the second winding slot is spaced apart from the third winding slot by a fourth distance; and
the third distance is equal to the fourth distance.

16. A method for constructing a motor having a concentrated winding construction, the method comprising:
determining simulated torque ripple for a plurality of proposed motors with various stator slot opening configurations;
identifying an optimized motor from the plurality of proposed motors based on the simulated torque ripple;
constructing a plurality of tooth segments, the plurality of tooth segments being configured to define a plurality of slot openings corresponding to the optimized motor when the plurality of tooth segments are arranged circumferentially, wherein at least one slot opening of the plurality of slot openings is asymmetric with respect to the plurality of slot openings; and
circumferentially disposing the plurality of tooth segments to form a stator.

17. The method of claim 16, further comprising disposing a respective set of stator windings about each tooth of the plurality of tooth segments prior to circumferentially disposing the plurality of tooth segments to form the stator.

18. The method of claim 16, wherein:
determining simulated torque ripple comprises performing finite element analysis for the plurality of proposed motors with the various stator slot opening configurations; and
identifying the optimized motor comprises identifying an iteration from the finite element analysis having a minimum torque ripple.

19. The method of claim 16, further comprising determining simulated torque output for the plurality of proposed motors with the various stator slot opening configurations, wherein identifying the optimized motor comprises identifying the optimized motor based on the simulated torque ripple and the simulated torque output.

20. The method of claim 19, further comprising performing finite element analysis for the plurality of proposed motors with the various stator slot opening configurations to obtain simulated torque ripple and simulated torque output for a plurality of design iterations, wherein:
identifying the optimized motor comprises identifying a design iteration of the plurality of design iterations having a reduced torque ripple and a minimal reduction in torque output.
